(19) United States
(12) Patent Application Publication
(10) Pub. No.: US 2020/0345174 A1
(43) Pub. Date: Nov. 5, 2020

(54) BUN PAN AND PROCESS FOR MAKING SAME

(71) Applicant: Robert Mayernick, South Bend, IN (US)

(72) Inventor: Robert Mayernick, South Bend, IN (US)

(21) Appl. No.: 16/932,179

(22) Filed: Jul. 17, 2020

Related U.S. Application Data
(63) Continuation-in-part of application No. 15/609,240, filed on May 31, 2017.
Application No. 15/609,240 is a continuation-in-part of application No. 15/245,956, filed on Aug. 24, 2016, now Pat. No. 10,512,272.
Application No. 15/245,956 is a continuation-in-part of application No. 14/152,074, filed on Jan. 10, 2014, now abandoned.
Application No. 14/152,074 is a division of application No. 13/553,868, filed on Jul. 20, 2012, now Pat. No. 8,870,151.

(51) Int. Cl. A47J 37/01; A21D 8/06; A21D 13/32

(52) U.S. Cl. CPC A47J 37/01; A21B 3/133; A21D 13/32; A21D 8/06

(57) ABSTRACT

A pan system is provided having a male mold portion extending from a base plate to create a pallet. Raw dough is rolled out to a sheet having a uniform thickness, which is then formed into a cut shape. The cut shape is placed to overlay the male mold portion and has overlapping seam areas. A guide is brought into proximity with the base plate and guides posts extend through the base plate. The housing is placed between the guide posts. The overlapping seam areas are bonded during the baking process due to being constrained by the housing and male mold portion.

### CROSS REFERENCE TO RELATED APPLICATIONS

This application is a Continuation-in-Part of U.S. application Ser. No. 15/609,240 filed May 31, 2017 which is a Continuation-in-Part of U.S. application Ser. No. 15/245,956, filed Aug. 24, 2016, which is a Continuation-in-Part of U.S. application Ser. No. 14/152,074 filed Jan. 10, 2014, which is a divisional of U.S. application Ser. No. 13/553,868 filed Jul. 20, 2012, the disclosure of which is hereby incorporated by reference.

### BACKGROUND OF THE INVENTION

A typical sandwich is formed having a filling disposed between two pieces of bread. A hamburger is one common sandwich, with a ground beef patty, vegetables and condiments disposed between an upper and lower bun. Sometimes the bread is hinged, such as is used with a hotdog or sausage. The common failing of these types of sandwiches is that they can be difficult to eat tidily when on the go—the sandwich filling can leak out of the bread while being eaten. As such an improved bun is needed for containing sandwich filling. The disclosure provided herein describes an improved pan for baking a bun suitable for use in making a variety of sandwiches (including, but not limited to, hotdogs, sausages, hamburgers, sub sandwiches, loose meat sandwiches, among many others).

### SUMMARY OF THE INVENTION

The present disclosure describes a pan for preparing an improved bun suitable for making various types of sandwiches. The pan described herein is composed of a base plate, a housing, an ejector plate, and a divider. The pan, when assembled, is shaped to form a pocket bun therein. The pan is designed to be disassembled in a way to allow ready ejection of the pocket bun from the pan.

The pan may include a single chamber for producing a single bun, or multiple chambers for producing multiple buns from a single pan. One chamber may include a single male mold for producing a bun having a single cavity, or multiple male molds for producing a bun having multiple cavities. The divider separates the chambers and may include openings to allow buns in adjacent chambers to form a baked connector therebetween for holding the buns together during packaging.

The pan of the present disclosure includes further improvements over previous pans, including providing a pan with means for ejecting deep-draw goods from the pan such as through a pneumatic system or use of ejection pins. In one configuration, the pan of the present disclosure produces a bun having a plurality of cavities, such that food stuffs are independently insertable into each cavity. In an additional configuration, the shape of either the exterior of the bun or the cavity of the bun is formed with a distinctive shape so as to provide unique brand-identifying capabilities. An optional top with a wing plate can help to form a portion of the outside to cause the bun to have a more defined outer shape and a controlled wall thickness.

An alternate manufacturing method involves rolling dough into a flat sheet and a design cut into the sheet into a defined shape. The defined shape is then laid over the mold, where sides overlap. Pressure pads may assist in conforming the defined shape to the mold. The sides that overlap are joined and then baked. Without the seaming process, the seam areas will not be secure and any baked bun will not be structurally sound. In some instances, failure of the seam would result in spilled food, stained clothing, or property damage. The defined shape may be laid over an array of molds, depending on the volume of buns or desired configuration. The array of buns baked therefrom may be further severed or partially severed using a creasing feature on the pressure pads. Instead of using the pressure pads to bond the seam areas, a housing can be placed over the cut shape and mold. When the dough expands during the baking process, the seam areas are bonded from the pressure created by the expansion of the baking dough.

### BRIEF DESCRIPTION OF THE DRAWINGS

A preferred embodiment of this invention has been chosen wherein:

FIG. 1 is a perspective view of a pan suitable for forming one or more hamburger-accommodating pocket buns;

FIG. 2 is an exploded view of the pan of FIG. 1;

FIG. 3 is a top view of the pan of FIG. 1;

FIG. 4 is a sectional side view of the pan of FIG. 3 as taken along line 4-4 and shown housing two buns;

FIG. 5 is a perspective view of a pan suitable for forming one or more hotdog-accommodating pocket buns;

FIG. 6 is a sectional side view of the pan of FIG. 7 as taken along line 6-6 shown housing two buns;

FIG. 7 is a top view of the pan of FIG. 5;

FIG. 8 is an exploded view of the pan of FIG. 5;

FIG. 9 is a perspective view of a pan showing the male mold having an octagon-shaped cross-section;

FIG. 10 is a perspective view of a pan showing the male mold having an oval-shaped cross-section;

FIG. 11 is a sectional side view of the pan of FIG. 1 and showing the ejector pins;

FIG. 12 is a sectional side view of the pan of FIG. 10, and showing an alternative ejector system;

FIG. 13 is a top view of a pan showing a divider providing an octagon-shaped outer cross-section to the buns;

FIG. 14 is a top view of a pan showing a divider providing an oval-shaped outer cross-section to the buns;

FIG. 15 is a sectional side view of a pan for forming a single bun having two cavities;

FIG. 16 is a perspective view of a bun formed from the pan of FIG. 15;

FIG. 17 is an exploded perspective view of the three piece pan;

FIG. 18 is an perspective view of the pan in FIG. 17 as assembled;

FIG. 19 is a section view 19-19 of the pan in FIG. 18;

FIG. 20 is an perspective view of the pan with an optional stuffer;

FIG. 21 is a section view 21-21 of the pan in FIG. 20;

FIG. 22 is a side view of a process for making a bun from a design cut shape;

FIG. 23 is a top isometric view of the pan system showing the structure used for cutting the design cut shape;

FIG. 24 is a top isometric view of the pan with the cut shape overlaying the male mold portion;

FIG. 25 is a section view 4-4 of the vacuum system in FIG. 24.

FIG. 26 is a top isometric view of the cut shape in FIG. 25 including the seam pressure pads;

FIG. 27 is a top isometric view of the device in FIG. 26 with the seam pressure pads contacting the cut shape;

FIG. 28 is a top isometric view of the pan system similar to the system shown in FIG. 23 using a simplified cut shape;

FIG. 29 is a top isometric view of the pan with the simplified cut shape overlaying the male mold portion;

FIG. 30 is a side view of a multi-cavity bun and pallet with a broken area 30 showing one of the male mold portions having dough surrounding it;

FIG. 31 is section view 31-31 of the bun and pallet shown in FIG. 30;

FIG. 32 is a partial view 32 of the bun and pallet shown in FIG. 31;

FIG. 33 is a top view of alternate shapes for the cut shape;

FIG. 34. is an isometric view of an ejection fork removing a baked bun;

FIG. 35 is an isometric exploded view of the outside guide pan system;

FIG. 36 is a section view of the outside guide pan system;

FIG. 37; is an isometric view of the cut shape overlaying the male mold portion and the removable guide;

FIG. 38 is an isometric view of the housing located by the removable guide;

FIG. 39 is an isometric view of the inside guide pan system; and

FIG. 40 is a section view of the inside guide pan system of FIG. 39.

### DESCRIPTION OF THE PREFERRED EMBODIMENT

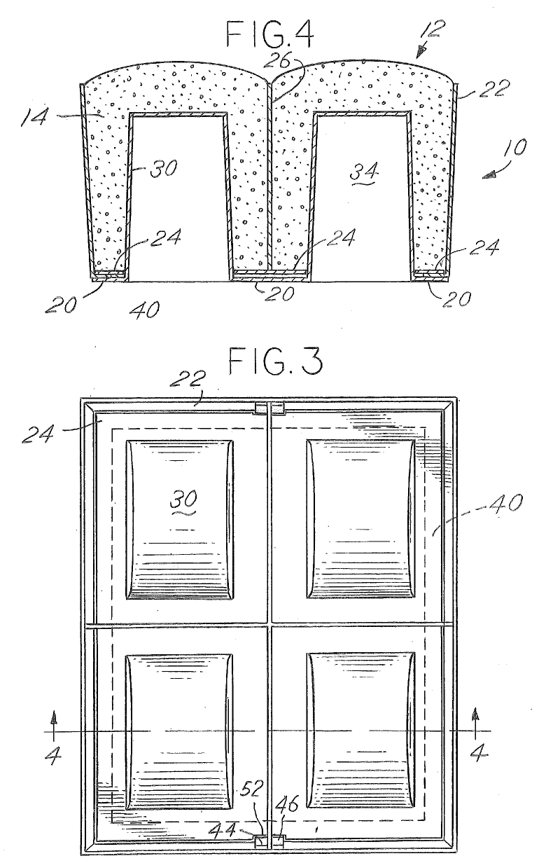

The present disclosure describes a pan 10 suitable for preparing a pocket bun 12. Pocket bun 12 is a molded object one embodiment of which is shown in FIG. 16, such as a food product or bun, formed having a wall 14 which defines a cavity 16 (other embodiments of bun 12 are shown in side-view in FIGS. 4, 6, 11, 12, and 15, where FIG. 16 shows a two-cavity bun, and the remaining figures show single-cavity buns). An opening 18 is formed through wall 14 and allows access to cavity 16. Cavity 16 and opening 18 together form an open mouth in pocket bun 12, with cavity 16 suitable for carrying food products, such as a hamburger, a hotdog, cold cuts, or any other food products and related condiments and dressings. The present disclosure is directed to pan 10, any references to pocket bun 12 should not be seen as limiting the uses of pan 10. It is understood that bun 12 formed in pan 10 is suitable for carrying a variety of sandwich fillings, and any reference to a specific type of filling is merely illustrative and does not limit the use of the bun. For example, any reference to hotdogs is only to illustrate the general shape of the bun, not to limit the bun from being used with other types of fillings.

As described herein, pan 10, and associated parts described in detail below, are referred to as having upper and lower ends. These designations are for ease of reference herein, with the upper end referring generally to the open top of pan 10, and the lower end referring generally to the base of pan 10 opposite the open top. It is understood that as used, pan 10 is positionable in any number of orientations, and as such any reference to upper and lower is not seen as limiting.

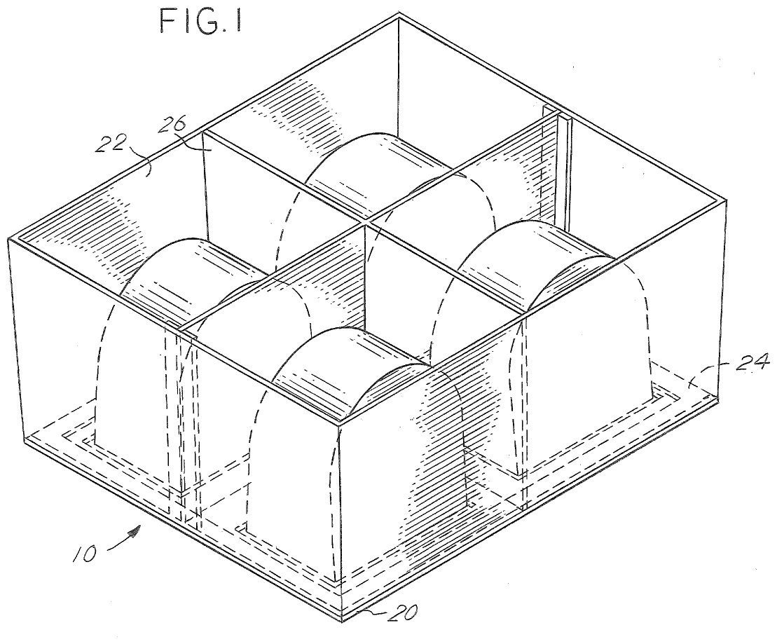

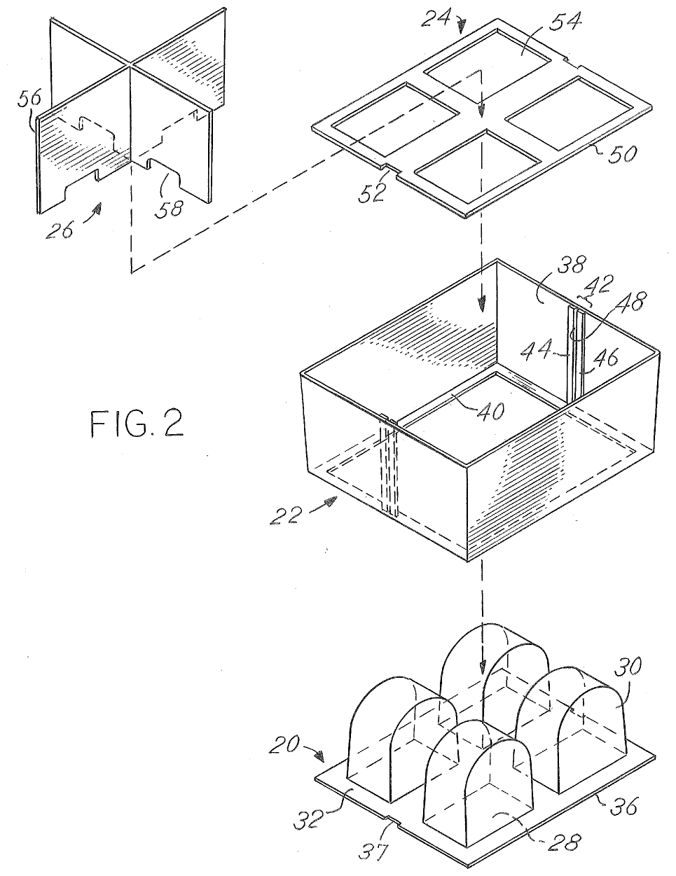

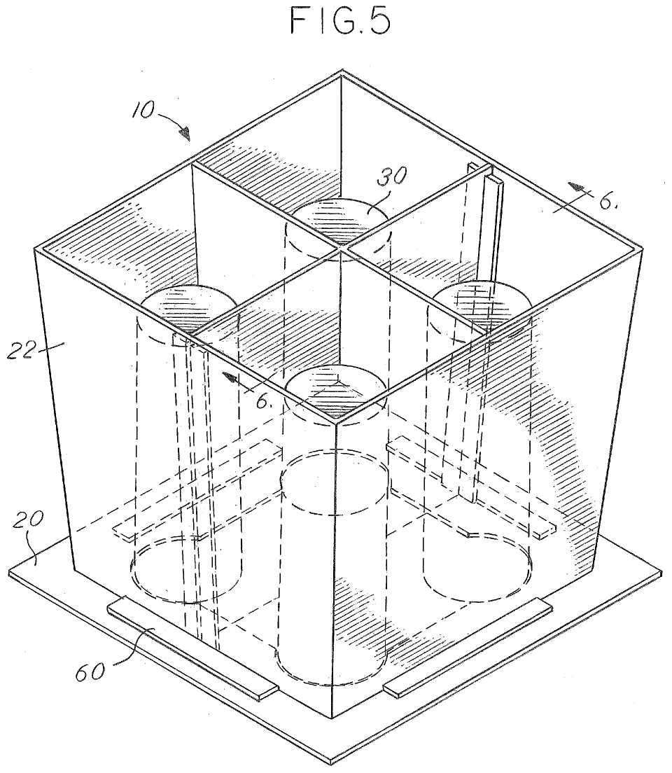

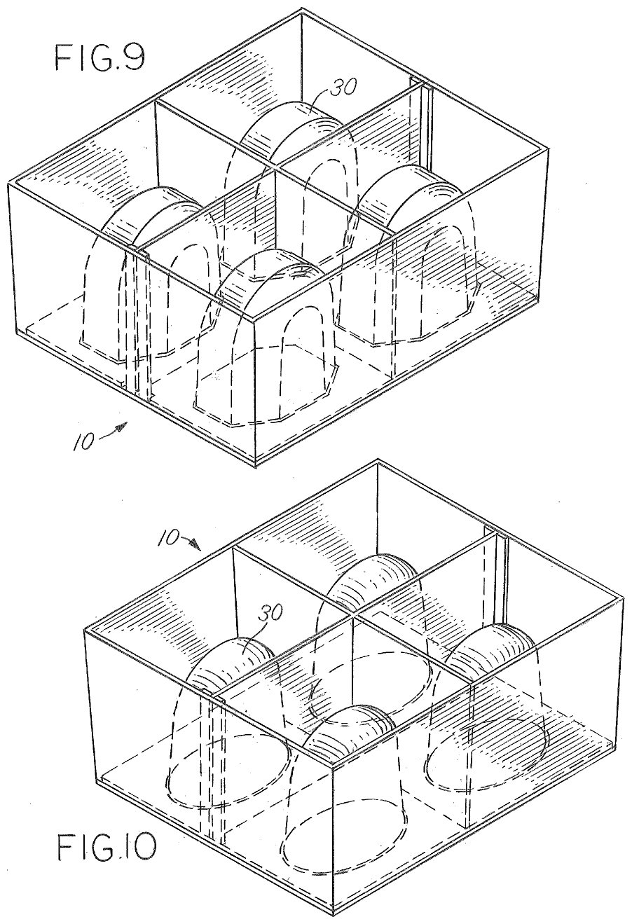

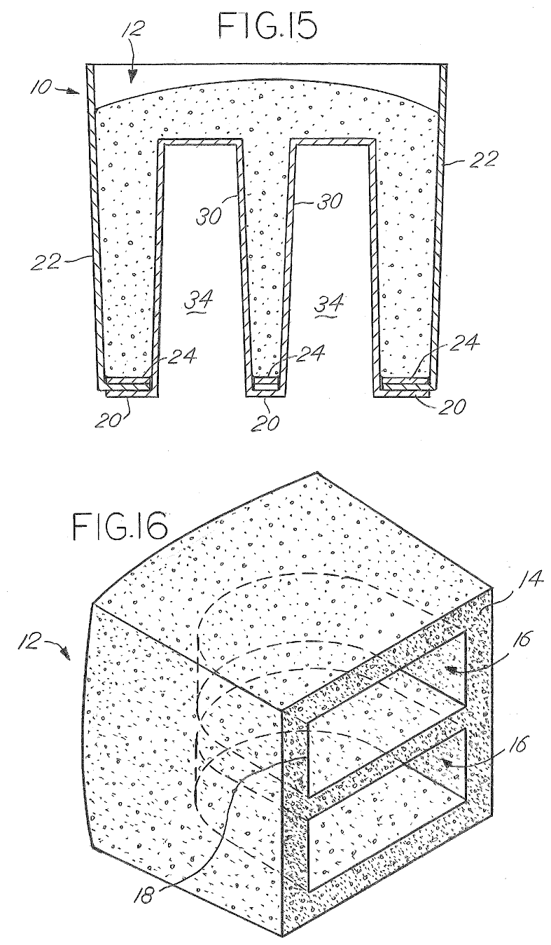

Pan 10 is formed from a group of nestable parts: a base plate 20, a housing 22, an ejection plate 24 and a divider 26, as shown assembled in FIG. 1 and in exploded view in FIG. 2. Base plate 20 is a generally flat plate having an aperture 28 passing therethrough and spaced inwardly from an outer edge 36. A male mold 30 extends from a top side 32 of base plate 20. Male mold 30 circumscribes aperture 28, such that male mold 30 defines a cavity 34 having an opening defined by aperture 28 (cavity 34 shown in FIG. 4). Male mold 30 is preferably tapered such that a cross-section of male mold 30 taken parallel to and proximate base plate 20 is larger than a cross-section of male mold 30 taken near the upper end. Male mold 30 is tapered to aid in ejecting bun 12 from pan 10. As shown in FIGS. 1-3, male mold 30 has a generally rectangular cross-section, though other cross-sections are suitable, see, for example, FIGS. 5-8 (round cross-section), FIG. 9 (octagon cross-section), and FIG. 10 (oval cross-section). Base plate 20 may include a single aperture 28/mold 30 combination, such as for preparing a single pocket bun 12, or alternatively may include an array of aperture 28/mold 30 combinations (as shown in FIG. 2), such as for preparing multiple pocket buns 12 using a single pan 10, or for preparing a single bun 12 having multiple cavities 16 (as shown in FIG. 15).

Housing 22, as shown in FIG. 2, is formed having an upright wall 38 defining an interior space, with a lip 40 extending inwardly from and inscribing the lower end of upright wall 38. When pan 10 is assembled, lip 40 overlies base plate 20. As shown in FIGS. 3 and 4, upright wall 38 is tapered such that the upper end is wider than the lower end, to ease removal of pocket bun 12 from pan 10. A guide 42 is positioned on the interior face of upright wall 38, with the guide formed from a first rail 44 and a second rail 46. First rail 44 is positioned generally vertically, and second rail 46 is offset from, and generally parallel to first rail 44. Rails 44, 46 are offset from one another such that a gap 48 is formed therebetween. The embodiment of housing 22 shown in FIG. 2 includes a pair of guides 42 positioned on facing surfaces of upright wall 38. In other embodiments, the number and positioning of guides 42 is variable depending on the number and positions of the aperture 28/mold 30 pairs of base 20. In additional embodiments, guides 42 are omitted from housing 22. It is contemplated that base 20 includes notches 37, such that base 20 is alternatively positionable sandwiched between housing 22 and ejector plate 24 with notches 37 locating base 20 relative housing 22.

Ejection plate 24 is defined as a generally flat plate having an outer edge 50. With pan 10 assembled, ejection plate 24 overlies lip 40 of housing 22. A notch 52 forms an indentation in edge 50, with notch 52 sized to straddle guide 42 when pan 10 is assembled, thereby notch 52 locates ejection plate 24 relative housing 22, as shown in FIG. 3. Ejection plate 24 includes an aperture 54 formed therethrough, aperture 54 is sized at least as large as the largest cross-section of mold 30, such that aperture 54 encircles mold 30 when pan 10 is assembled.

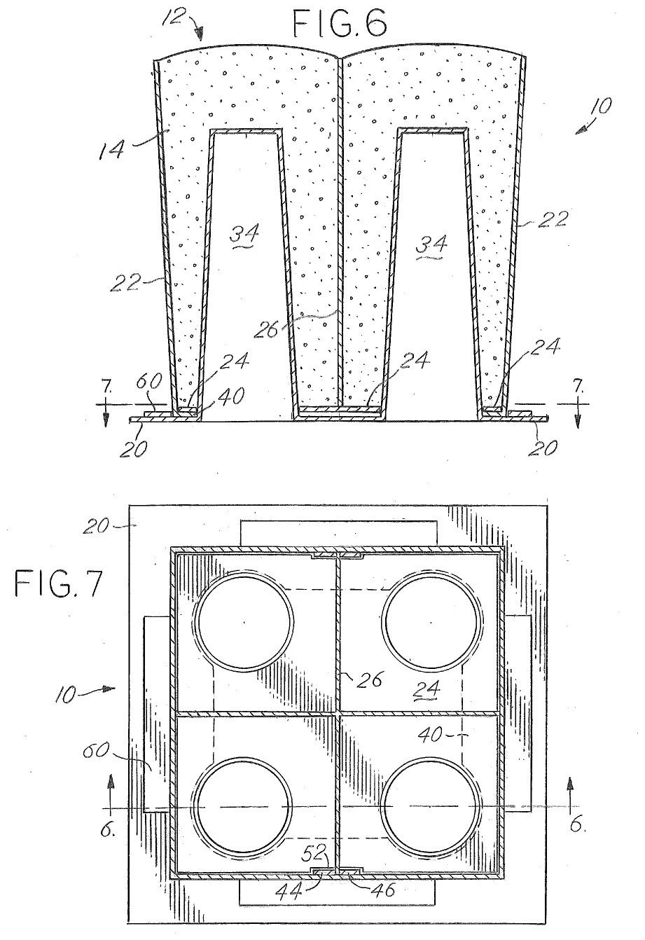

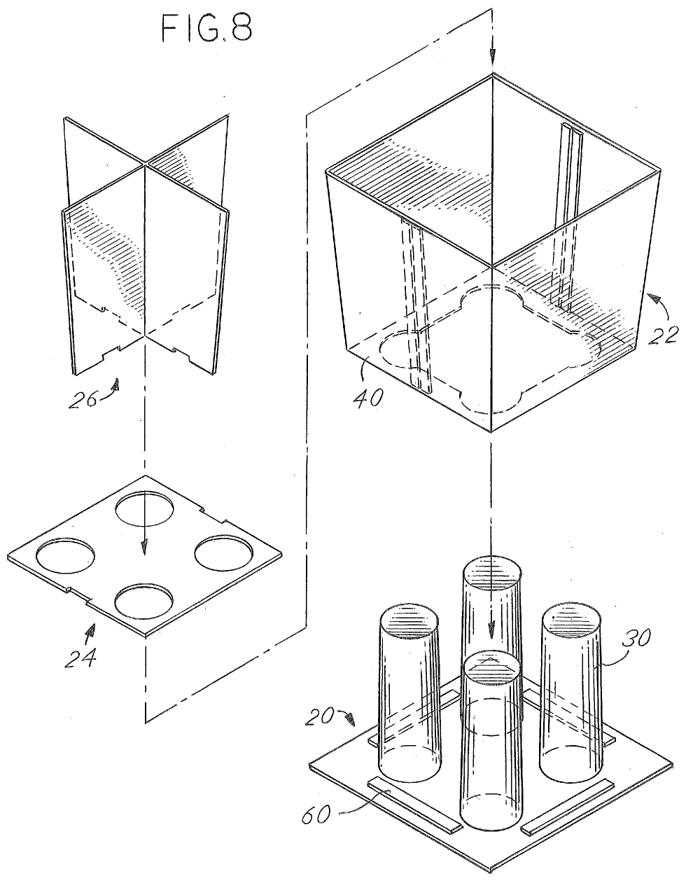

Divider 26 is defined as an upright plate overlying ejection plate 24 and subdividing the interior of housing 22 into multiple chambers. In the embodiments shown in FIGS. 2 and 8 divider 26 is X-shaped, with four plates joined together at the intersection formed therebetween. With pan 10 assembled, an outer edge 56 of divider 26 is located at gap 48 between first rail 44 and second rail 46 of guide 42, such that guide 42 retains divider 26 at a specified position within housing 26. Divider 26 includes a gap 58 formed at the bottom edge of divider 26. FIGS. 3 and 7 show a top view of pan 10 as assembled, where divider 26 is used to subdivide the pan into four quadrants, with each quadrant forming a chamber suitable for baking a pocket bun 12. Gap 58 provides an opening between adjacent chambers to allow adjacent pocket buns 12 to be joined together, such as to aid in keeping groups of pocket buns 12 together during processing or shipping. Gap 58 may be positioned at any of many suitable positions on divider 26, such as at the outer corners of divider 26 or at the intersection between the plates, or spaced between the corners and intersection as is shown in FIG. 2. It is contemplated that gap 58 may be omitted, thereby providing a pan 10 which completely segregates buns 12

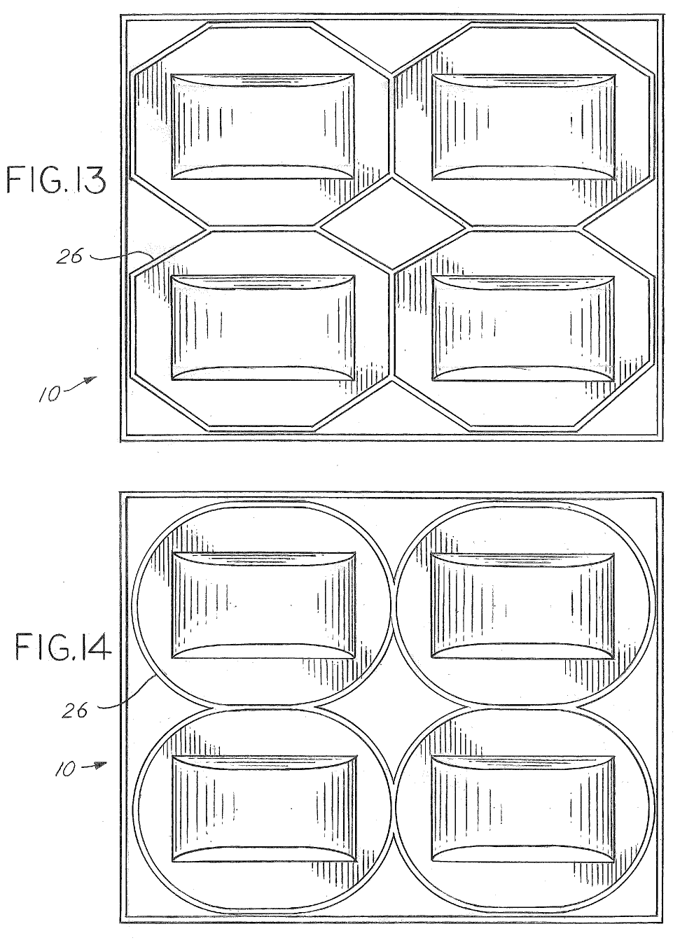

It is contemplated, such as is shown in FIGS. 13 and 14, that divider 26 is shaped other than as an X to form buns of different shapes. It is also contemplated that divider 26 may be omitted and the resulting buns may be sliced into individual buns in a separate step. It is contemplated that gap 58 is omitted such that divider 26 forms a complete partition between adjoining chambers.

FIG. 3 is a top view of pan 10 showing ejection plate 24 overlying lip 40 of housing 22 (lip 40 shown in dotted line). Notch 52 of ejection plate 24 locating ejection plate 24 in house 22 relative guide rails 44, 46. Male molds 30 are shown extending up through ejection plate 24. It is contemplated that ejection plate 24 may be omitted.

FIG. 4 shows a side view of pan 10. Pocket bun 12 is shown in pan 10. FIG. 4 shows how the constituent parts of pan 10 stack together, with divider 26 overlying ejection plate 24, ejection plate 24 overlying lip 40 of housing 22, and lip 40 overlying base 20. Male mold 30 extends upwardly through ejection plate 24 into housing 22.

Referring now to FIGS. 5-8, in one embodiment pan 10 is shaped to form a bun 12 suitable for carrying a hotdog and associated condiments. As will be appreciated by comparing FIG. 1 and FIG. 5, each embodiment includes the same constituent parts: base 20, housing 22, ejection plate 24 and divider 26, the main difference being the relative dimensions and shape of the parts. For example, housing 22 of FIG. 5 is generally taller than that of FIG. 1 to allow for the forming of a long bun shaped to carry a hotdog. Similarly, male mold 30 of FIG. 5 has a circular cross-section to accommodate a hotdog.

FIG. 8 shows an exploded view of the constituent parts of the pan 10 of FIG. 5. FIG. 8 shows housing 22 and lip 40, with lip 40 contoured to match the shape of male molds 30. Base 20 includes spacers 60 which serve to locate housing 22 on base 20. Spacers 60 are raised bosses or strips extending from the surface of base 20 which contact the outer wall of housing 22 when pan 10 is assembled. FIG. 1 shows an embodiment of pan 10 which omits spacers 60. It is envisioned that pan 10 of FIG. 1 could be modified to include a spacer 60 by enlarging the dimensions of base 20. Likewise, it is envisioned that pan 10 of FIG. 8 could be modified to omit spacer 60.

FIG. 6 shows a cross-sectional side view of the embodiment of pan 10 showing how the constituent parts overly one another in assembled form. FIG. 6 is comparable to FIG. 4. Similarly, FIG. 7 is comparable to FIG. 3 in showing a top view of the respective embodiments of pan 10.

FIGS. 9 and 10 show alternative shapes of male mold 30. FIG. 9 shows male mold 30 having an octagon-shaped cross-section. FIG. 10 shows male mold 30 having an oval-shaped cross-section. As is clear from FIGS. 9 and 10, male mold 30 is formable in any one of many possible cross-sectional shapes, which in turn forms the internal cavity of pocket bun 12 in the corresponding shape. As such, the shape of male mold 30 can be customized to allow for a specific type of food, or to allow for distinctive marketing or branding. The shape of male mold 30 may be customized on either the hamburger or hotdog accommodating bun pans. The cross-sections shown herein are merely illustrative, and should not be viewed as limiting. Such cross-sections are preferably polygon shaped. Such cross-sections are more preferably equi-angular polygons such as: triangle, square, pentagon, hexagon, heptagon, or octagon. Other shapes which provide brand-identification are suitable.

FIG. 11 shows a sectional side view of pan 10, showing an auto-ejection system having ejection pins 62. Ejection pins 62 pass through apertures in base 20 such that when actuated, ejection pins 62 apply a force to ejection plate 24, to force bun 12 away from pan 10. Ejection pins 62 may be mechanically, pneumatically, electrically, manually, or otherwise actuated. Alternatively, ejection plate 24 is omitted and ejection pins 62 force housing 22 away from base 20, and housing 22 urges bun 12 out of pan 10. It is contemplated that base plate 20 is carried above lip 40 of housing 22, such that pin 62, when actuated, forced base 20 up and away from housing 22. Additionally, it is contemplated that pin 62, when actuated, contacts bun 12 directly, causing bun 12 to come free from pan 10.

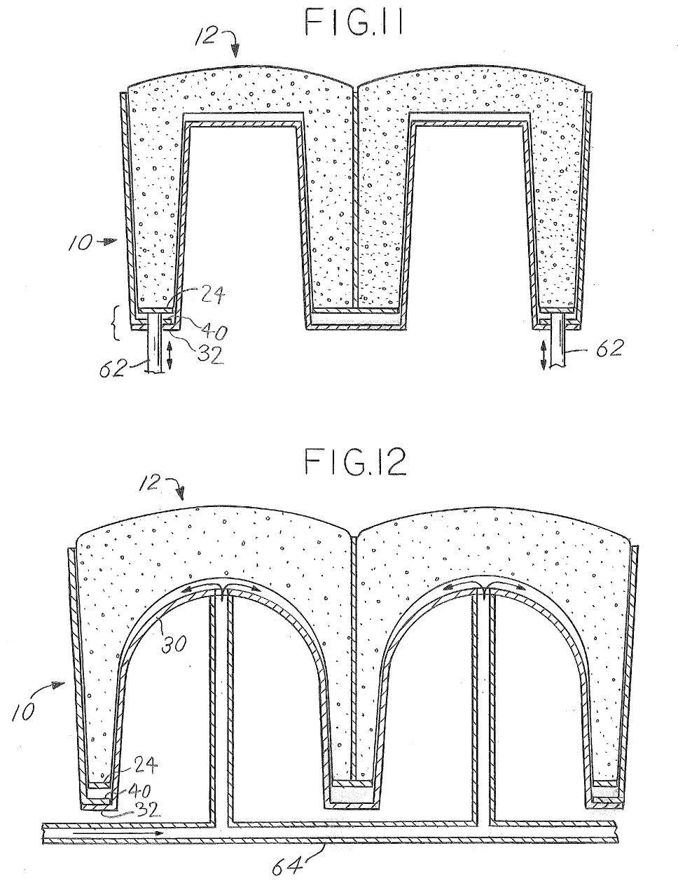

FIG. 12 shows a sectional side view of pan 10 having an air manifold 64 for providing a pneumatic release system to pan 10, whereby air is used to force bun 12 free from pan 10. Manifold 64 is in fluid communication with apertures in male mold 30, such that when activated, air forces bun 12 away from pan 10. It is contemplated that ejector plate 24 may be omitted where manifold 64 is used to eject bun 12 from pan 10.

FIGS. 13 and 14 show alternative shapes of divider 26, such as to form a pocket bun 12 having an octagon-shaped outer cross-section (as in FIG. 13), or a pocket bun 12 having an oval-shaped outer cross-section (as in FIG. 14). The shape of divider 26 may be selected to yield the outer cross-section desired for a given pocket bun 12. The outer cross-section and cavity cross-section of pocket bun 12 may each be independently selected to yield a pocket bun 12 having desired characteristics, such as for brand identification or similar distinctive aesthetic enhancement of bun 12. The cross-sections shown herein are merely illustrative, and should not be viewed as limiting. Such cross-sections are preferably polygon shaped. Such cross-sections are more preferably equi-angular polygons such as: triangle, square, pentagon, hexagon, heptagon, or octagon. Other shapes which provide brand-identification are suitable.

In one embodiment, a bun is formed having a pair of inner chambers. This embodiment is useful for building a three-layer sandwich, such as bun-filling-bun-filling-bun, as is common at some fast food restaurants. An example of this embodiment is shown in FIGS. 15 and 16. Here, pan 10 includes a pair of male molds 30 without a divider between them such that a bun 12 is formed having a pair of cavities. The dimensions shown in FIG. 16 are merely illustrative, the dimensions of bun 12 (such as the thickness of wall 14 or the relative size of cavity 16) may be varied according to the type of bun which is desired. The same can be said for a bun formed having a single cavity.

One advantage of bun 12 formed by pan 10 over prior art breads is that pan 10 forms a bun where both the outer surface and the cavity surface of bun 12 has a browned surface. Most buns, for example a common hamburger bun, have a browned outer surface, but the inner surface is not browned, but is formed by splitting the bread open. The present bun 12 includes an inner cavity having a browned surface such that when a filling is placed in the bun the filling contacts a browned surface and the browned surface serves to minimize the bread becoming soggy by resisting absorption of moisture from the filling. In this way, pan 10 bakes a bun 12 which resists becoming soggy.

The outer surface of bun 12 is browned either by direct contact from heated air when baking (such as is the case at the open top of pan 10), or by conductive heat transferred from pan 10 to the bun. Base plate 20 includes apertures 28 through which heated air enters the internal cavity of male mold 30, such that male mold 30 is heated during baking so as to brown the inner cavity 16 of bun 12. Browning the inner cavity 16 of bun 12 provides the beneficial effect of forming a filling-accepting portion of bun 12 which is resistant to becoming soggy.

Pan 10 is formed from a material sufficient at least to withstand the heat of baking, to retain shape when baking, and to transfer heat to brown bun 12 when baking. Such materials include, but are not limited to, aluminum, steel and other metals, silicone, tempered glass, ceramic, or composite. Any of such materials may include a non-stick coating. Pan 10 is formed having an open top wherein the open top allow gases to escape from the pan when bun is being baked.

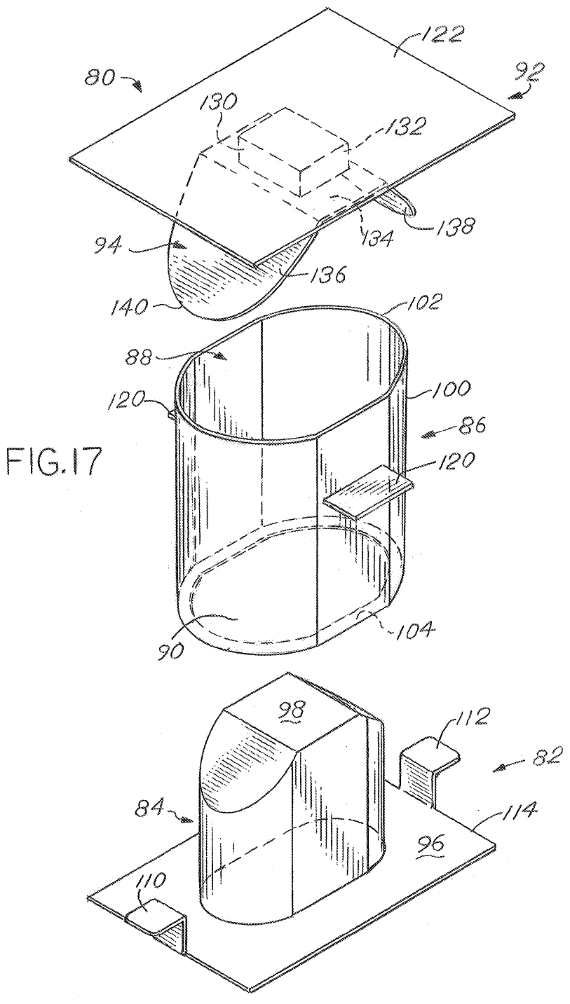

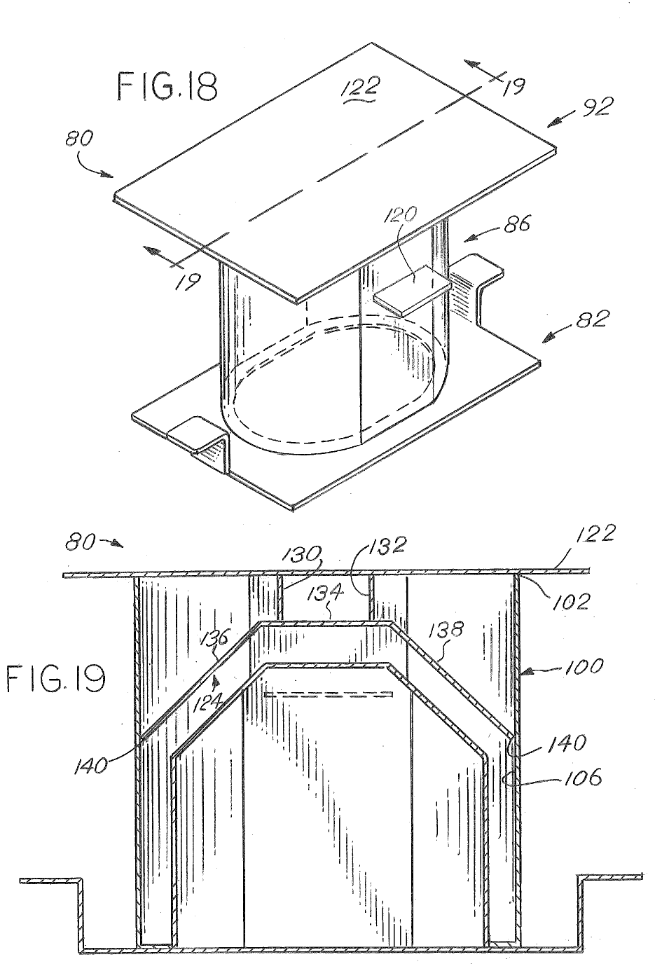

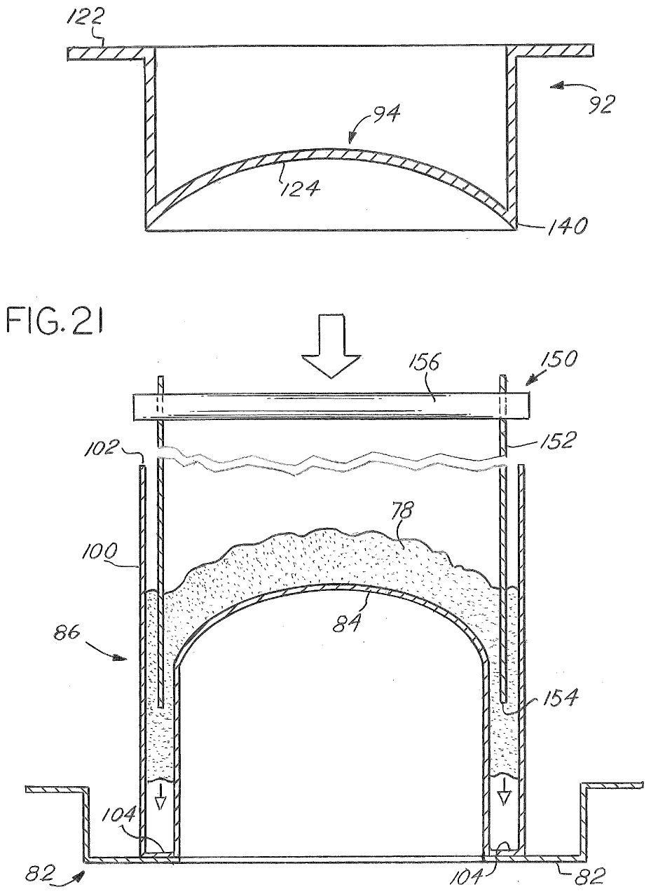

An embodiment of the pan 80 is shown in FIGS. 17-21. In this embodiment, the dough 78, as seen in FIG. 21, is formed and baked over a base plate 82 with a male mold portion 84. As shown in FIG. 17, the pan 80 includes a housing that has an open top 88 and an aperture 90 for receiving the male mold portion 84. The pan 80 further includes a top cap 92. The top cap 92 has a wing plate 94 that extends into the housing 86. The base plate 82, housing 86, and top cap 92 enclose the pan 80 to constrain the dough as it is being baked. The assembled pan 80 and enclosed volume are shown in the section view FIG. 19.

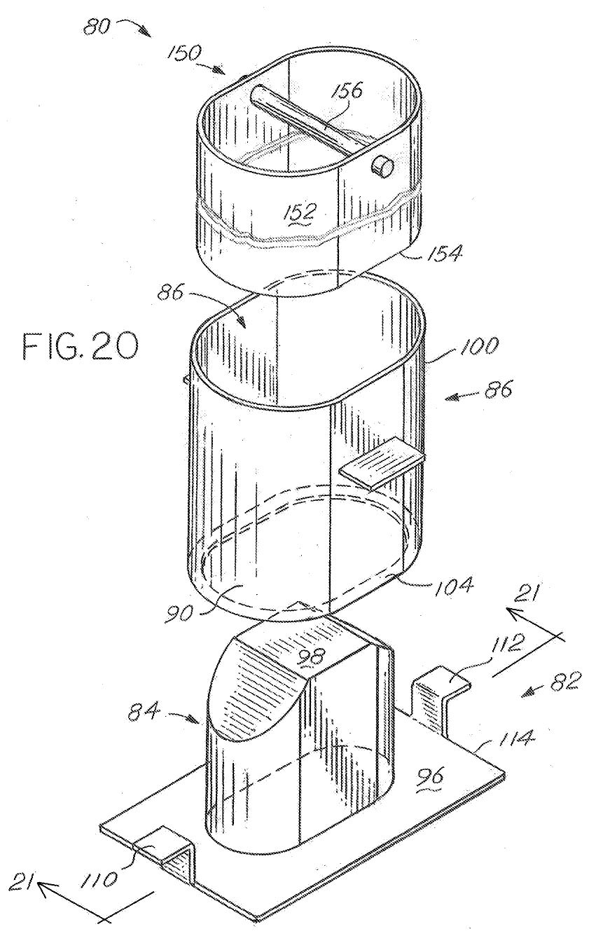

The base plate 82 has the male mold portion 84 that extends from a planar portion 96. The male mold portion 84 and planar portion 96 form a continuous surface, shown in FIGS. 17 and 20. The outer surface of the male mold portion 84 is designed to be in direct contact with dough 78 and baked bread, as the outside shape is designed to form the inside pocket of a bun as it is baked. The male mold portion 84 is shown as tapered, also known as draft, which assists the male mold portion 84 to release the dough once it is baked into a bun. At the end of the male mold portion 84 is a terminal end surface 98. The terminal end surface 98 is spaced from the planar portion 96 by a first distance. The terminal end surface 98 can have different shapes, based on the style of bun and anticipated ingredients for the bun. As previously described, the male mold portion 84 is smallest at the terminal end surface 98. While the embodiment shown is tapered, it is anticipated that the male mold portion 84 is straight. The base plate 82, particularly the planar portion 96, has handles 110, 112. Each handle 110, 112 extends outwardly from the perimeter edge 114 of the planar portion 96. The handles 110, 112 are used by automation equipment to grasp the base plate 82 and remove it from the housing 86. The handles 110, 112 are shown as extending outwardly, but other features are anticipated to assist automation equipment.

The housing 86 has a continuous upstanding wall 100 with a top edge 102 and a bottom wall 104 with the aperture 90. The top edge 102 is shown as a smooth continuous edge. The bottom wall 104 is continuously attached where it intersects the upstanding wall 100. As previously described, the bottom wall 104 has an aperture 90 that is sized to receive the male mold portion 84. The size and shape of the aperture 90 closely match the male mold portion 84 when the base plate 82 is mated with the housing 86. Matching the sizes closely between the aperture 90 and the male mold portion 84 allow dough to be inserted into the mold without dangers of leakage as the dough is baked. The upstanding wall has an inside surface 106 and an outside surface 108. The housing 86 further includes ejection tabs 120. The ejection tabs 120 allow automation equipment to grasp the housing 86 to allow baked bread to be ejected. The ejection tabs 120 are shown as extending outwardly from the outer surface of the continuous upstanding wall 100 but other devices or features that allow for ejection are contemplated. Further, it is contemplated that the housing 86 is formed from two or more parts that would separate to allow baked bread to be more easily removed from the pan 80. A housing 86 with the ability to separate would also allow more complex shapes of bread to be baked without concern of removing baked bread from the pan 80. The housing 86 may have a tapered portion adjacent the top edge 102 to allow positioning error without mechanical interference when the top cap 92 is inserted. The distance between the top edge and the bottom wall is greater than the distance between the terminal end surface 98 and the planar portion 96. When inserted into the housing 86, the terminal end surface 98 is below the top edge 102.

The top cap 92 has a planar portion 122 and the wing plate 94, as in FIG. 17, is attached to and extends from one side of the planar portion 122. The wing plate 94 has an outwardly facing surface 124, as in FIG. 21, that is complimentary to the terminal end surface 96 of the male mold portion 84. As assembled into the complete pan 80, the terminal end surface 96 is spaced from the outwardly facing surface 124. The complimentary nature of these surfaces allows for flexibility of the shape of the bun while still retaining more uniform wall thickness in a baked bun. This is visible in FIGS. 19, 21. The wing plate 94 is spaced from the planar portion 122 with spacing walls 130, 132, see FIG. 19. The spacing walls 130, 132 are optional and only serve to space the wing plate 94 from the planar portion 122. The wing plate 94 has a middle section 134, a side section 136 and a second side section 138. The side sections 136, 138 are obliquely angled with respect to the middle section. These sections form the outwardly facing surface 124, in FIG. 19. The wing plate 94 further includes a perimeter edge 140. The perimeter edge 140 is sized and shaped to be in close proximity or contact with the inside surface 106 of the continuous perimeter wall 100 when the wing plate 94 is inserted into the housing 86. It is contemplated that the wing plate 94 is flat, curved, or other shape. As shown in FIG. 21, the wing plate 94 and outwardly facing surface 124 may be formed similarly to the base plate and have a continuous surface.

Because some dough is more viscous than other dough, a stuffing ram 150, as in FIG. 20, may be required. The stuffing ram 150 has a continuous wall 152 with a leading edge 154. The ram 150 is open to allow air to move through the ram 150 as it is being inserted or withdrawn from the pan 80. As shown in FIG. 21, the leading edge 154 presses through the dough, driving it downwardly. The continuous wall 152 is shaped to temporarily reside between the male mold portion 84 and the continuous upstanding wall 100. The stuffing ram 150 is used to drive dough 78 down into the area of the pan 80 that is nearest the bottom wall 104. It is contemplated that pressure or vacuum will assist or be used to move the dough to fill the mold. The ram 150 includes a gripping feature 156 that is attached to opposing sides of the continuous wall 152. The gripping feature is used to allow automation equipment to insert and remove the ram 150. As described, the ram 150 is used only to insert the dough and is not present for the baking process. It is contemplated that the gripping feature 156 utilizes different features that would be used by automation equipment, such as tabs, through-holes, or gripping areas.

To make baked bread with the pan 80, the user starts with a clean housing 86 and inserts the base plate 82 into the aperture 90. Dough 78 is then dispensed above the open top 88, where it drops onto the male mold portion 84, typically the terminal end surface 96. The dough 78 may fill in the voids near the bottom wall 104, based on the size of the mold and viscosity of the dough 78. At that point, the optional stuffing ram 150 is inserted, driving the dough 78 downwardly. This step is shown in FIG. 19. After the dough is placed into the pan 80 and driven sufficiently downward toward the bottom wall 104, the ram 150 is removed and the top cap 92 is installed, where the perimeter edge 140 is in close proximity or touching the inside surface 106 of the continuous perimeter wall 100. The assembly of these parts creates a mostly closed cavity where the dough will expand and fill as it bakes. Gaps between adjacent parts allow gases to escape.

To eject the baked bread, the top cap 92 and base plate 82 are removed from the housing 86. This allows the baked bread to be ejected from the housing. Once the parts are cleaned, the pan 80 is ready for another baking cycle. As is well known in the art, it is common to apply a non-stick coating or surface on any part that may contact a food product, particularly one that is baked.

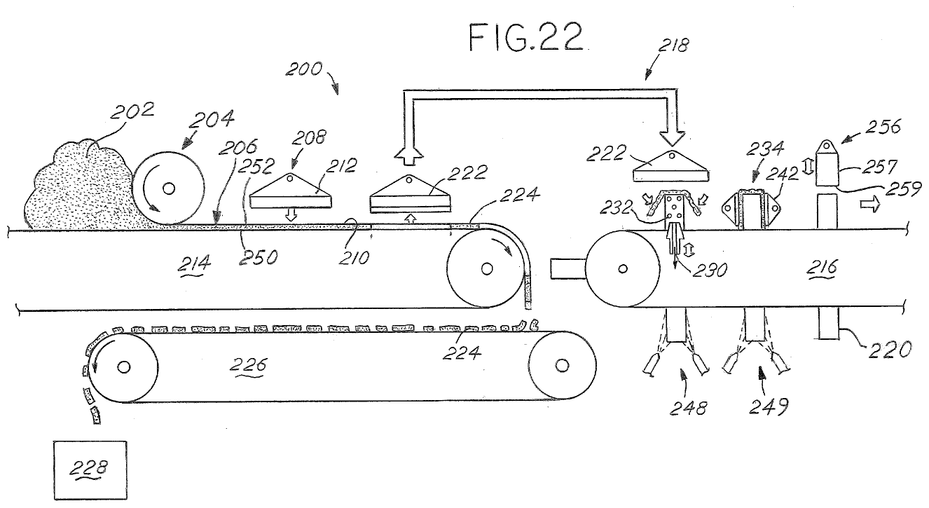

An alternate embodiment of the pan and process 200 is shown in FIGS. 22-27. The process 200 creates a pocket bun from a design cut shape 210 from a sheet of dough. The alternate embodiment utilizes the same or similar base plate 82 and male mold portion 84 as shown in FIG. 17 however it does not necessarily use the top cap 92 or housing 86. A cut shape 210 is laid over the male mold portion 84, the seams are joined, and it is baked.

An overview of the process for making the bun in FIG. 22. Bulk raw dough 202 is placed on a cutting conveyor 214 and rolled at a rolling station 204. The dough leaves the rolling station 204 as a uniform sheet 206. A cutting station 208 uses a die 212 to create a cut shape 210. The cut shape 210 is then transferred from the cutting conveyor 214 to a second conveyor 216. A transfer station 218 moves the cut shape 210 by removing it from the cutting conveyor 214 and raising it over a waiting pallet 220. The transfer station 218 may incorporate a suction head 222 that moves over the cut shape 210 and uses vacuum to pull the cut shape 210 from the cutting conveyor 214. Dough scraps 224 fall off the end of the cutting conveyor 214 and on to a transfer conveyor 226, where they are collected into a bin 228 for subsequent re-use. A waiting pallet 220 is comprised of the previously disclosed male mold portion 84 and base plate 82. While not explicitly shown, the previously disclosed handles 110, 112 or another process friendly feature may be incorporated onto the base plate 82. Process friendly features and pallets 220 are well-known in the art. The suction head 222 with the cut shape 210 moves over the top of the pallet 220, where it releases the cut shape 210. The cut shape 210 overlays the male mold portion 84. An optional vacuum system 230 mates with the pallet 220 and applies vacuum to the inside area of the male mold portion. When the optional vacuum system 230 is utilized, the male mold portion 84 has a series of apertures 232 that draw the cut shape 210 toward the male mold portion 84 when vacuum is applied. The apertures 232 are sized so that dough is not permanently drawn into them, where it would be difficult to remove a baked bun. The apertures 232 may be selectively placed or the male mold portion 84 could be made from a stiff mesh or compacted porous material. Next, seams 240 are sealed at a pressing station 234 where pressure pads 242 apply pressure to the seams 240 and seam areas 258 to compress and seal the lap joints 244, making a formed shape 246. Before the pressing station 234, portions of the cut shape 210 may be wetted with a bonding agent to allow the overlapping areas of the dough to more easily be joined and sealed. The pressing station 234 may also compress any portion of the cut shape 210 that is not in contact with the male mold portion 84 in the event that the vacuum system 230 is not present. Instead of using pressure pads 242, it is contemplated that the cut shape is pressed to conform with the male mold portion 84 by hand. After the lap joints 244 are sealed, the formed shape 246 and pallet 220 pass through a trimming station 256 that cuts off extra unbaked dough with a trimming die 257. The trimming die 257 is sized larger than the male mold portion 84 and can encircle the male mold portion 84 with the cutting edge 259 contacting the base plate. Excessive dough that overlays the base plate 82 is trimmed off and reused or repurposed. After trimming, the trimmed and formed shape enters an oven (not shown) to be baked. Conveyor ovens are well-known in the art. After baking, the baked bun is removed from the pallet 220. As previously discussed, the male mold portion 84 may be coated with a non-stick coating, and further, the base plate 82 may also include the same coating. The removal can be done using gravity, such as when the mold is turned upside down on the second conveyor 216. Further, other removal steps or structure may be implemented, such as an ejection fork shown in FIG. 34 or other mechanism that strips the baked bun from the male mold portion 84. The pallet 220 then returns and passes through a cleaning station 249 to prepare it for re-use. The cleaning station 249 may incorporate mechanical cleaning, such as brushes or compressed air. The cleaning station 249 may use water or a cleaning solution that is sprayed and then dried. The next station may be a coating station 248, where a non-stick coating is applied to the pallet 220. Alternatively, the outside surface of the male mold portion 84 may have a permanent non-stick coating.

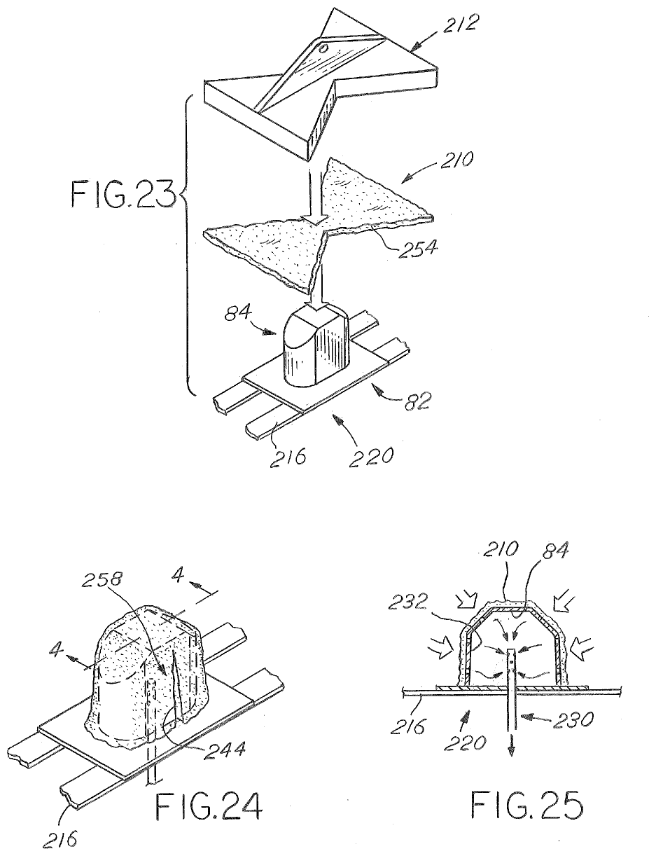

Details of the components used in the process 200 will now be described. As previously explained, a sheet of dough 206 is cut into a cut shape 210 as shown in FIG. 23. The uniform sheet 206 and cut shape 210 has an inner surface 250 and an outer surface 252. As shown in FIG. 22, the inner surface 250 is in direct contact with the cutting conveyor 214 with the outer surface 252 facing up. The cut shape 210 has a perimeter edge 254 that defines the boundary of the shape. The size and shape of the cut shape 210 and profile of the perimeter edge 254 is determined by the size and shape of the male mold portion 84 it will overlay. While the dough is still soft and malleable, the cut shape 210 is laid over the pallet 220, typically centered over the male mold portion 84 and gravity begins to move the dough downwardly to conform to the male mold portion 84. Portions of the cut shape 210 overlay to create lap joint 244 areas where the dough is double the thickness. It is important to ensure the lap joints 244 are securely bonded, so pressure pads 242 are brought into contact with the lap joints 244 and pressure is applied to bond them.

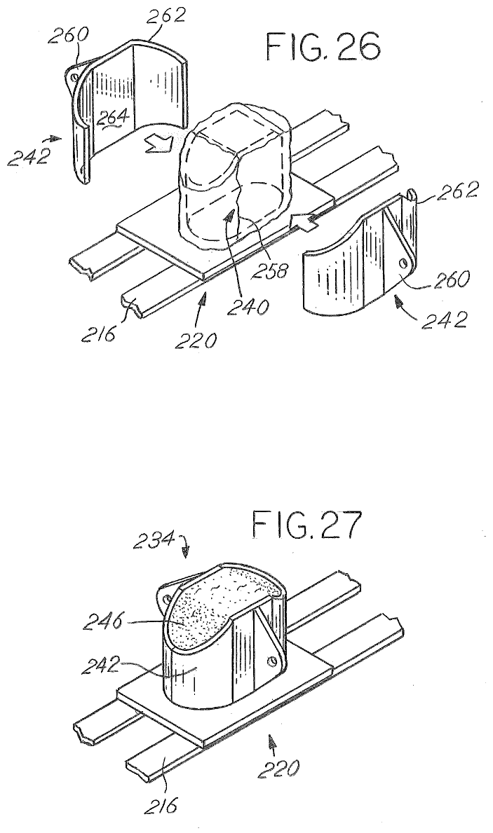

The pressure pads 242 are shown in FIG. 26. The embodiment as shown uses two pressure pads 242, but other shapes may require a different quantity. For example, if the geometry of the male mold portion 84 and the seams 240 are located on four sides, four pressure pads 242 may be required. Each pressure pad 242 has a mounting portion 260 and a pressure plate portion 262. The pressure plate portion 262 is shown as a curved and formed sheet of metal, but other shapes and materials are contemplated. The pressure plate portion 262 has an outwardly facing surface 264 that has a complimentary curvature or profile to the seam area 258 of the male mold portion 84 where the seams 240 are located. FIG. 27 shows the pressure pads 242 in direct contact with the seams 240.

To further clarify the variations of the cut shape 210, the dough being cut into the cut shape 210 in preparation for forming over the male mold portion 84 can exist in many forms. Some of the basic forms are listed below but this does not cover all potential designs. These designs are applicable for various bun shapes and configurations. These include but are not limited to buns that are designed to carry a sausage or a patty of meat and/or other ingredients.

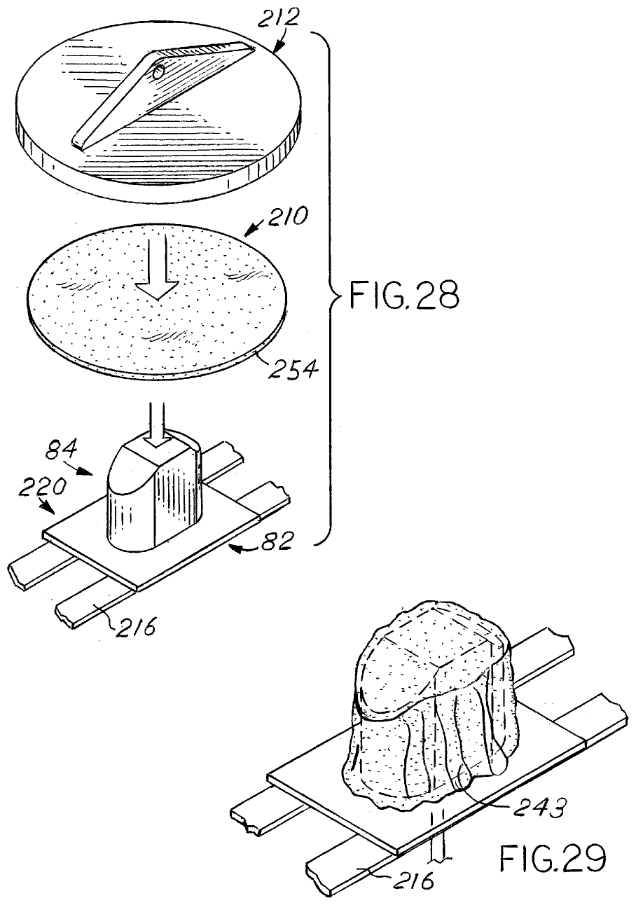

The various shapes for the cut shape 210 are a result of the outer surface of the male mold portion 84. The cut shape 210, as shown in FIG. 23, has a geometrically calculated area and predefined shape for location of the seam areas 258 as it is laid over the male mold portion 84. One option for the cut shape 210 is simple, such as a circle, square, or other simplified shape. The simplified version of the cut shape 210 is shown in FIGS. 28 and 29. The simplified cut shape 210 shape is then laid over the male mold portion 84 as shown in FIG. 29 and sides of the bun dough are folded around the male mold portion 84 to form the molded shape to be trimmed and then baked. Some trimming of the dough is done with the trimming die 257 for final shape. The folds 243 of the dough are structured similarly to the aforementioned seam areas 258 which are then squeezed using the pressure pads 242. This makes the dough a single mass with substantially uniform wall thickness without any air pockets or separation.

Another option is to use a cut shape 210 that is more complex than the simplified shape as previously discussed but more simple than the calculated area. In this option, the cut shape 210 has a single seam area 258 when laid over the male mold portion 84. The single seam is similar to the seamless but the dough is pulled around the male mold portion 84 for its shape. The seam may then be sealed with the pressure pad 242 and some of the folds 243 that occur in the seamless process are trimmed with the trimming die 257. Instead of using pressure pads 242, it is contemplated that the cut shape is pressed to conform with the male mold portion 84 by hand.

The double seam dough pattern more matches the male mold portion 84 to simulate the mold total surface area if it is laid out in a flat pattern. Thus, when the cut shape 210 is laid over the male mold portion 84, it covers the mold without having any folded dough areas. All seams are created with some overlap so that the seams may be sealed together with an outside force such as the pressure pads 242 squeezing the overlapping seam areas 258 together.

An ejection fork 270, shown in FIG. 34 may be implemented to remove the baked bun from the male mold portion 84. The fork 270 would be slid into position where the male mold portion 84 meets the base plate 82. The fork would then strip the baked bun off of the male mold portion 84, where it could be collected for further processing, storage, or transport.

Multiple seam design cut patterns can also be made to conform to the male mold design by more exact cutting of the pattern to the “laid out” surface area of the bun shape. This could be 3, 4, or more cuts or seams. Again, these cuts become overlapped when placed on the male mold portion 84 to create seam areas 258 so they in turn can be squeezed together and bonded, forming a continuous dough shape to be baked. In the event that the cut shape 210 has no seams to overlap, as it is laid out over the male mold portion 84, the dough will have folds that are similar to the overlapping seam areas 258. In this case, the pressure pads 242 will be used to compress and join the overlap areas and conform the cut shape 210 and allow it to retain the shape of the male mold portion 84 as it is baked.

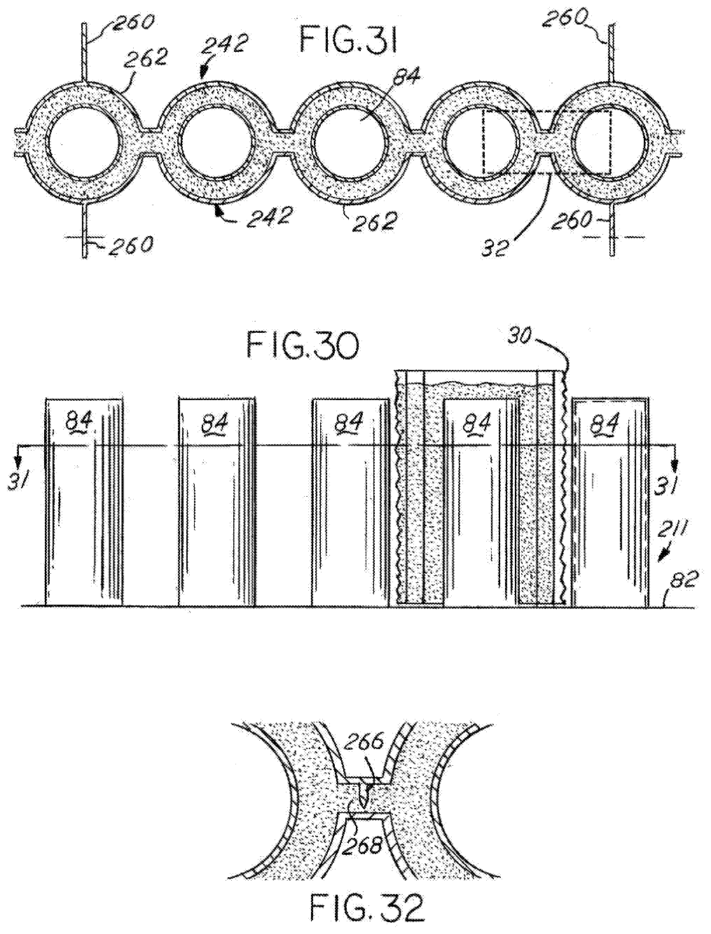

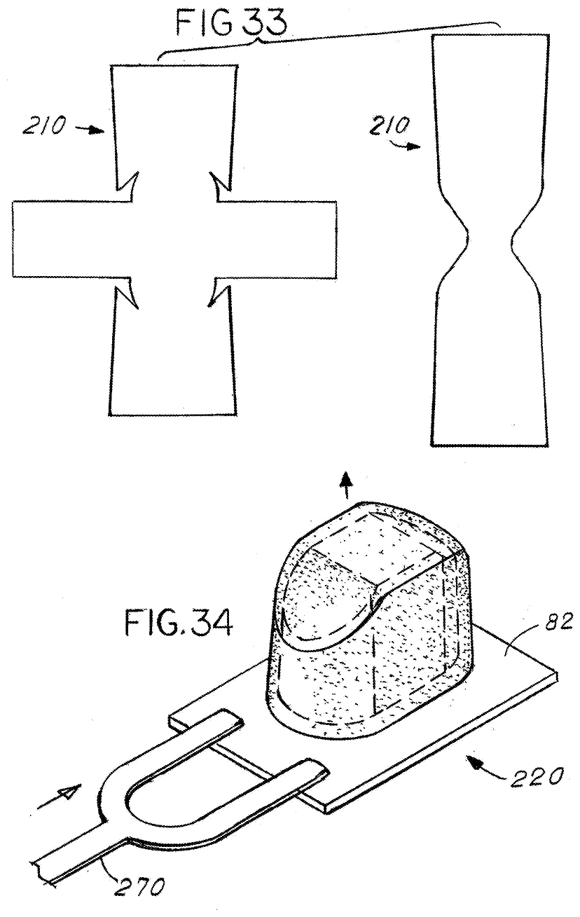

Depending on the desired geometry of the finished product and/or production requirements, the process 200 may implement a multi-bun pallet 211, shown in FIG. 30. In this embodiment, the pallet 211 has a base plate 82 with a series or array of male mold portions 84 as shown in FIGS. 30-32. For simplicity, FIG. 30 shows only one of the male mold portions 84 with dough surrounding it, but the dough would surround all the male mold portions 84, as shown in FIG. 31. In this embodiment, the cut shape 210 is a long single piece of dough that is simultaneously laid over all of the male mold portions at the transfer station 218. When the cut shape 210 overlays the male mold portions 84, the dough may be pressed against them at pressing station 234 using the pressure pads 242. The vacuum system 230 previously described may also press the dough to the male mold portions 84. The pressure pads 242 shown in FIGS. 30-32 simultaneous press the cut shape 210 onto the array of the male mold portions 84. In this embodiment, the pressure pads 242 may also incorporate a creasing feature 266 that will cut through or cut partially into the dough that is located between adjacent male mold portions 84. The creasing feature 266 is shown as located in a joining area that compresses areas of the dough. The joining area compresses the dough to join and seal it before being baked. The creasing feature 266 makes a weakened area 268 where adjacent buns are connected. This would allow adjacent buns to be separated either by the end user or at the end of the process, where the baked buns are removed from the pallets. The creasing feature 266 may partially sever the dough or completely sever it, depending on the desired configuration of the baked bun.

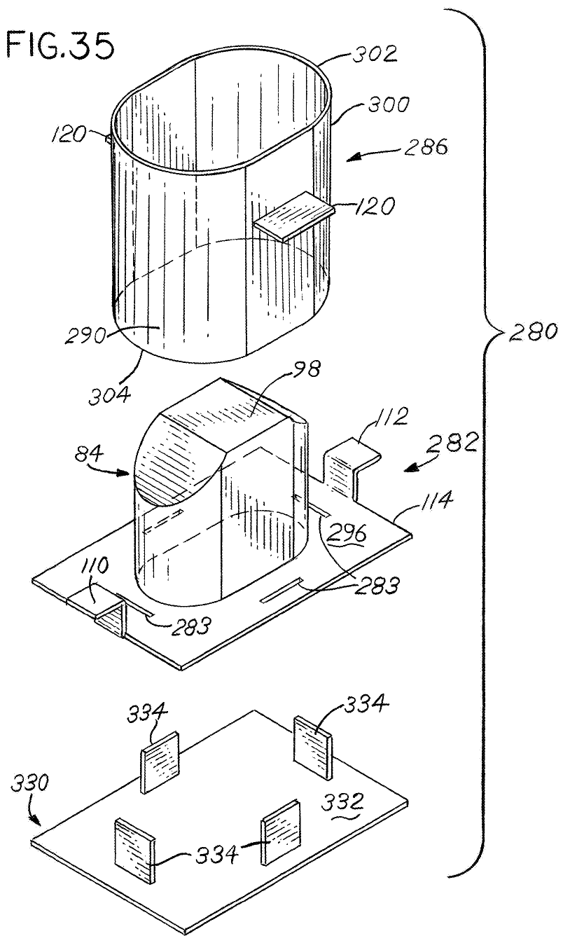

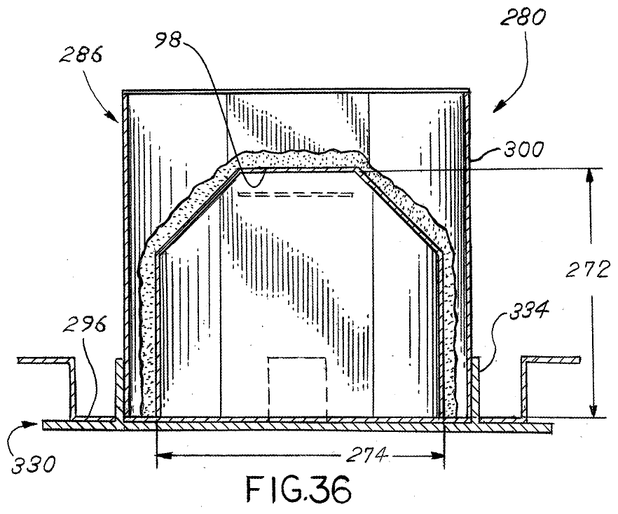

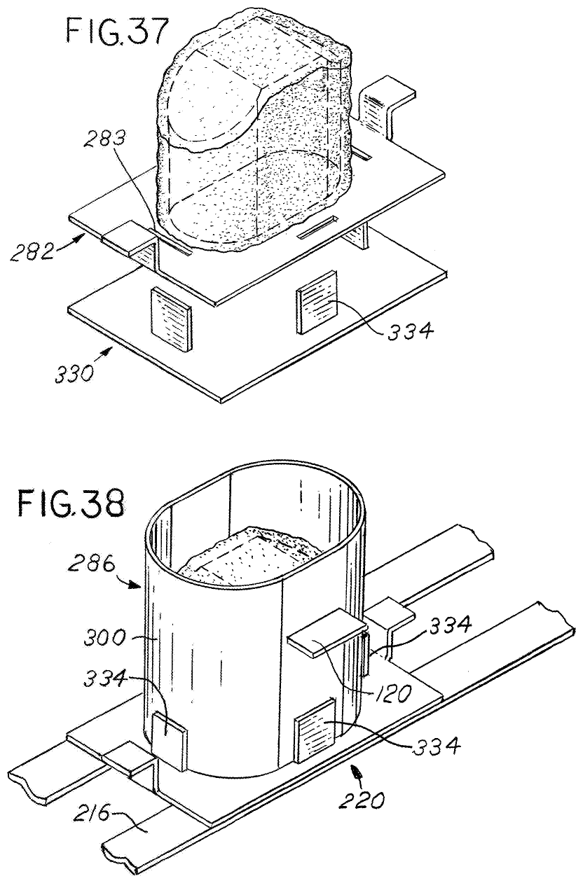

FIGS. 35 through 38 show an alternate version of the pan system 280 using outside guides to locate a housing 286 over a base plate 282. The base plate 282 is similar to base plate 82, but includes guide holes 283 through the planar portion 296. The base plate 282 has a male mold portion 84. The housing 286 shares many of the features with housing 86, but does not have a bottom wall 104. This version of the pan system 280 provides the benefit of allowing a cut shape to be placed over the male mold portion 84 before the housing 286 is located. This is particularly useful when the desired bun shape is deep. A deep bun shape is defined as a bun that is deeper than it is wide. As it relates to the male mold portion 84, the depth 272 is the distance from the terminal end surface 98 to the planar portion 296 and is larger than the width 274 is the distance across the male mold portion 84 where it meets the planar portion 296. The dimensions are not tied specifically to a shape, but an example of the measurements is shown in FIG. 36. As shown in FIG. 35, the continuous upstanding wall 300 has an inside surface, an outside surface, a top edge 302 and a bottom edge 304 that surrounds the opening 290. The continuous upstanding wall 300 is simple and smooth on the inside surface. The housing 286 has ejection tabs 120 to assist with automation. With the housing 86 shown in FIG. 17, the bottom wall 104 served to align the housing 86 with the male mold portion 84. Because the housing 286 lacks that wall, a different method of alignment is needed. The pan system 280 includes a removable guide 330 that has a guide platform 332 which positions guide posts 334. The guide posts 334 align with guide holes 283 as shown in FIG. 36. While shown as flat tabs, the guide posts 334 can take many different shapes, such as cylindrical posts, tapered pins, or any feature that serves to position the housing 286 to the male mold portion 84.

The process to bake a bun using the alternate pan system 280 is as follows. First, the dough 202 is flattened at the rolling station 204 and cut at the cutting station 208 as shown in FIG. 22. The cut shape 210 is located and placed on the male mold portion 84. This operation is identical to the process shown in FIG. 23. At this time, the removable guide 330 is not installed to prevent any part of the cut shape 210 from getting caught or snagged on the guide posts 334. Once the cut shape 210 is located on the male mold portion 84, the removable guide 330 is mated to the base plate 282, bringing the guide posts 334 through the guide holes 283. Next, the housing 286 is brought down over the male mold portion 84 and located between the guide posts 334 with the bottom edge 304 in contact with the planar portion 296. The guide posts 334 prevent or limit fore-aft or side-to-side movement or position error of the housing 286. If any portion of the cut shape 210 extends past the bottom edge 304, it is severed by the bottom edge 304. This alignment sets a uniform distance between the outside surface of the male mold portion 84 and the inside surface of the upstanding wall 300, shown in FIG. 36. The cut shape 210 with seam areas 258 and lap joints 244 is now located within the upstanding wall 300. The assembly as shown in FIG. 36 then travels into an oven (not shown) to be baked. As the baking process starts, the dough forming the cut shape 210 begins to expand and become restricted by the male mold portion 84 and upstanding wall 300. As it expands, the dough is still flexible and “sticky,” meaning that the seam areas 258 and lap joints 244 can bond if slight pressure is applied. The slight pressure occurs by the expansion of the dough as it is constrained. For the seam areas 258 and lap joints 244, the expansion and simultaneous restriction results in these areas becoming bonded without the need for pressure pads 242.

Once the cut shape 210 is fully baked, the removable guide 330 and housing 286 are separated, leaving the bun on the male mold portion 84 as shown in FIG. 34. The fork 270 can then be used to remove the baked bun.

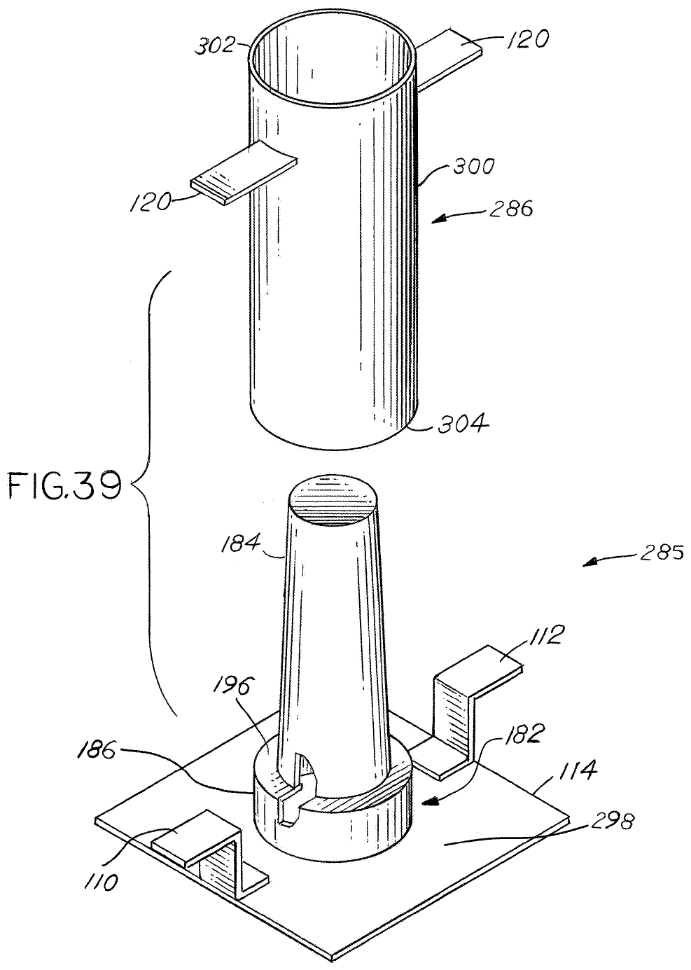

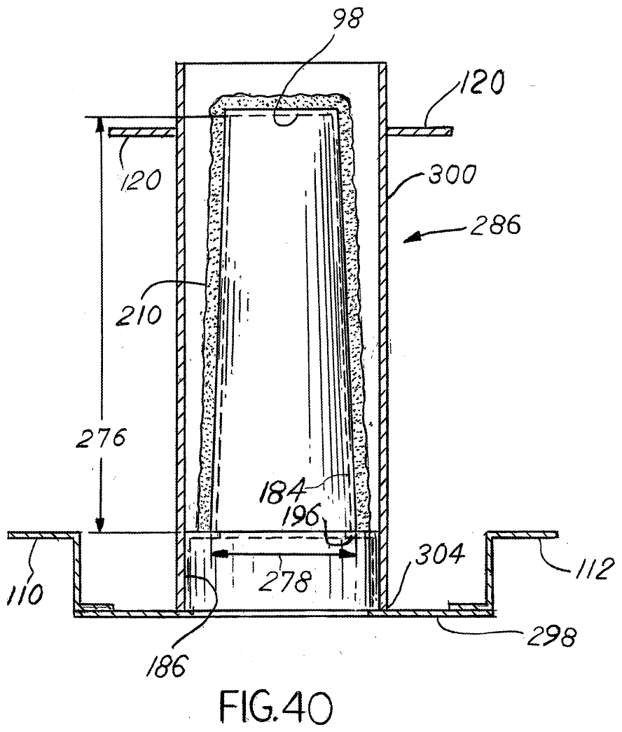

Instead of aligning the housing 286 with the male mold portion on the outside with the removable guide 330, alignment can be accomplished by adding a step on the base plate 285 between the male mold portion 184 and the planar portion 298 as shown in FIGS. 39 and 40. The housing 286 remains simple without a bottom wall. In this embodiment, the male mold portion 184 includes a pilot surface 186 that closely matches the inside surface and shape of the housing 286. The male mold portion 184 is spaced from the planar portion 298 by the locating step 182, which is made up of the pilot surface 186 and offset planar portion 196. Handles 110, 112 extend outwardly from the perimeter edge 114 of the planar portion 298. The embodiment shown in FIGS. 39 and 40 is a more extreme example of a deep bun. The dimension for the depth 276 is measured from where the male mold portion 84 meets the offset planar portion 196 and the width 278 is the distance across where the male mold portion 84 meets the offset planar portion 196. Making a deep bun creates unique challenges not applicable to shallow buns. The most difficult aspect is making sure the dough is properly located before baking begins, as improper dough placement or an improperly filled baking device results in a deformed or unusable finished product. In the embodiment shown in FIG. 20, a dough stuffing ram 150 was implemented to drive the dough deep into the mold due to the fact that the housing had to be in place before the dough was placed. With this embodiment, the dough is placed before the housing 286, allowing for full coverage of the male mold portion 84 with the cut shape 210. As can be seen in FIG. 40, the housing 286 is aligned with the pilot surface 186, with the cut shape 210 of dough being constrained between the male mold portion 184 and inside surface of the housing 286. Any dough that may extend beyond the outer edge of the offset planar portion 196 will be trimmed or otherwise separated when the housing 286 is put into place. As with the alternate pan system 280, the expansion of the dough as it is baked, along with the restricted areas between the housing 286 and male mold portion 184 apply pressure to any seams to seal them.

The shape of the components is merely for common shapes for food, and the designs contained herein are not limited to these shapes. While the system shown in FIGS. 35-38 makes a bun more shaped to accept a patty and the system shown in FIGS. 39-40 makes a bun more shaped to accept a sausage, the designs are not limited to these shapes. The system shown in FIGS. 35-38 with the guide posts 334 can be adapted to make a bun shaped to accept a sausage, and the system shown in FIGS. 39-40 with the pilot surface 186 can be adapted to make a bun shaped to accept a patty.

It is understood that while certain aspects of the disclosed subject matter have been shown and described, the disclosed subject matter is not limited thereto and encompasses various other embodiments and aspects. No specific limitation with respect to the specific embodiments disclosed herein is intended or should be inferred. Modifications may be made to the disclosed subject matter as set forth in the following claims.

What is claimed is:

1. A method of baking a bun using a pan system with a base plate having guide holes extending through said base plate, said guide holes surrounding a male mold portion, said pan system having a housing with a bottom edge and a removable guide having upstanding guide posts for mating with said guide holes, said upstanding guide posts for locating said housing with respect to said male mold portion when said removable guide is mated to said base plate and said housing is located over said male mold portion, said method comprising:
providing a cut shape from unbaked dough;
overlaying said male mold portion with said cut shape to form overlapping seams in said cut shape;
mating said removable guide with said base plate so that said guide posts pass through said guide holes in said base plate so that said guide posts extend beyond a planar portion in a direction of said male mold portion;
positioning said housing over said male mold portion and between said guide posts so that said guide posts circumscribe said housing adjacent to said bottom edge;
contacting said bottom edge of said housing with said base plate to form a uniform distance between said housing and said male mold portion;
baking said cut shape with said housing constraining said cut shape; and
removing a baked bun from said male mold portion.

2. The method of claim 1, further comprising the step of bonding and sealing said overlapping seams when said dough rises and is constrained between said male mold portion and said housing.

3. The method of claim 1, further comprising trimming a portion of said cut shape when said cut shape extends beyond where said housing contacts said base plate.

4. The method of claim 1, wherein overlapping seams are formed when said cut shape overlays said male mold portion.

5. The method of claim 1, further comprising the step of pressing said bottom edge of said housing against said planar portion so that a portion of said cut shape extending beyond said housing is trimmed.

6. The method of claim 1, wherein said male mold portion has a terminal end surface spaced from said base plate by a first distance, a second distance defined by a width of said male mold portion where said male mold portion meets said base plate, said first distance being larger than said second distance.

7. A method of baking a bun using a pan system with a base plate having a male mold portion extending therefrom including a pilot surface thereon adjacent to said base plate and terminating at an offset planar portion, said offset planar portion spaced above said planar portion, said pan system having a housing with a bottom edge and an inside surface adjacent to said bottom edge complementarily matching said pilot surface, said pilot surface for locating said housing with respect to said male mold portion when said housing is located over said male mold portion, said method comprising:
providing a cut shape from unbaked dough;
overlaying said male mold portion with said cut shape to form overlapping seams;
positioning said housing over said male mold portion and locating said pilot surface inside said housing adjacent said bottom edge;
contacting said bottom edge of said housing with said base plate to fix a distance between said housing and said male mold portion above said offset planar portion;
baking said cut shape with said housing constraining said cut shape; and
removing a baked bun from said male mold portion.

8. The method of claim 7, further comprising the step of bonding and sealing said overlapping seams when said dough rises and is constrained between said male mold portion and said housing.

9. The method of claim 7, further comprising trimming a portion of said cut shape when said portion of said cut shape extends beyond where said offset planar portion meets said pilot surface.

10. The method of claim 7, wherein overlapping seams are formed when said cut shape overlays said male mold portion.

11. The method of claim 7, wherein said male mold portion has a terminal end surface spaced from said offset planar portion by a first distance, a second distance defined by a width of said male mold portion where said male mold portion meets said offset planar portion, said first distance being larger than said second distance.

12. A pan system adapted for baking a bun from a cut shape of unbaked dough, said pan system comprising:
a base plate having a planar portion and a male mold portion extending therefrom, said planar portion having a plurality of guide holes extending therethrough and located around said male mold portion;
a housing having a smooth inside surface and a bottom edge;
a removable guide having upstanding guide posts for mating with said guide holes, said upstanding guide posts for locating said housing with respect to said male mold portion when said removable guide is mated to said base plate and said housing is located over said male mold portion;

13. The pan system of claim 12, when said cut shape overlays said male mold portion, said dough conforms to said male mold and portions of said cut shape overlap to form at least two seam areas; and

14. The pan system of claim 13, when said cut shape is baked with said housing located on said base plate by said removable guide and said guide posts, said seam areas are joined.

15. The pan system of claim 12, wherein said base plate has a plurality of male mold portions extending therefrom.

16. The pan system of claim 12, wherein said male mold portion has a terminal end surface spaced from said base plate by a first distance, a second distance defined by a width of said male mold portion where said male mold portion meets said base plate, said first distance being larger than said second distance.

17. A method of uniformly filling a deep mold with dough, said method comprising:
providing a base plate having a male mold portion including a pilot surface thereon adjacent to said base plate and terminating at an offset planar portion, said offset planar portion is spaced above said planar portion, said male mold portion extending from said offset planar portion, said male mold portion having a depth defined by a first distance between a terminal end surface and said offset planar portion, said male mold portion having a width defined by a second distance across said male mold portion where said male mold portion meets said offset planar portion, said first distance being larger than said second distance;
providing a housing with a bottom edge and an inside surface adjacent to said bottom edge complementarily matching said pilot surface, said pilot surface for locating said housing with respect to said male mold portion when said housing is located over said male mold portion;
providing a cut shape of unbaked dough;
placing said cut shape over said male mold portion so that said cut shape overlays said male mold portion;
placing said housing surrounding said cut shape so that said pilot surface is covered by said housing;
forming an overlapping seam when said cut shape is placed over said male mold portion;
baking said cut shape while said cut shape is located between said housing and said base plate; and
joining said overlapping seam by constraining said dough between said male mold portion and said housing during said baking.

18. The method of claim 17, further comprising trimming a portion of said cut shape when said portion of said cut shape extends beyond where said offset planar portion meets said pilot surface.
